(19) United States
(12) Patent Application Publication
(10) Pub. No.: US 2011/0168586 A1
(43) Pub. Date: Jul. 14, 2011

(54) METHOD FOR MARKING MULTIPLE COMPONENTS

(75) Inventors: Stefan Glueck, Schweinfurt (DE); Thomas Rink, Waldfenster (DE)

(73) Assignee: SCHAEFFLER TECHNOLOGIES GMBH & CO. KG, (DE)

(21) Appl. No.: 13/063,245

(22) PCT Filed: Sep. 3, 2009
(86) PCT No.: PCT/DE2009/001244

§ 371 Date: Mar. 10, 2011

(30) Foreign Application Priority Data
Sep. 11, 2008 (DE) 10 2008 046 812.6

(51) Int. Cl. B65D 85/00; G06K 19/07; G06K 1/18

(52) U.S. Cl. 206/307; 235/492

(57) ABSTRACT

A method for marking multiple components, each of which has at least one transponder and a storage device. A first marked component comes in contact with second components disposed in the range thereof and transmits information to them. The components mark themselves while taking the information transmitted by the first component into consideration. At least one second component after the marking thereof comes in contact with further components in the range thereof that are not marked yet in order to bring about the marking thereof. A group of components marked in this way, a corresponding container for carrying out the method, and a rolling bearing, which is a possible component to be marked in this way, are also disclosed. As a result, the self-organization and marking of a group of components is achieved with the help of an interconnected network.

### FIELD OF THE INVENTION

The invention is in the field of machine engineering and electrical engineering and relates, in particular, to the marking of components.

In technology, apart from the pure function of components, the reliability thereof and the quality control which is carried out for this purpose increasingly play an ever greater role.

Individualization and corresponding marking of components is already an important aspect for quality control in the production process and also subsequently during maintenance. By means of a marking process it is possible for individual components to be assigned to specific production batches, and when faults occur the entire batch can therefore be subjected to immediate maintenance or even be replaced provided that the individual components can be tracked.

In the production process it may be important to mark each individual component with information which denotes the production steps already passed through and/or the parameters which have occurred in the process. Dimensions and/or other properties of the components can also be added to a corresponding identifier. Information about the manufacturing time is often added to this in order to permit the age and the state of wear of components to be subsequently related to one another.

In order to be able to conveniently mark components, electronic means such as storage devices and communication interfaces have been increasingly introduced in the last few years, with which storage devices and communication interfaces it is possible to acquire corresponding information on the components by means of writing and reading devices and to provide the components with additional information.

RFID (radiofrequency identification) technology, which operates using transponders which work with radio waves and using corresponding storage devices, has played an outstanding role here. It has now become possible to implement corresponding transponders in an extremely functionally reliable and robust fashion together with small dimensions.

However, a particular feature of such transponders is the, under certain circumstances, restricted range in the vicinity of metallic objects, which makes it difficult, for example, to correspondingly address components which are present as bulk material and which are themselves composed of metal, or components which are located in a metallic container.

EP 1777599 A1 has disclosed a method for performing quality control with mechanical elements, which method makes use of electronic identifiers for the components with contactless communication processes which are used to store information about individual product steps in the component itself and therefore make said information available for later quality controls.

DE 112004002234 T5 discloses a roller bearing having what is known as an IC marking which is based on RFID technology and which permits the storage of data in the bearing itself. This document addresses the problem that running ring elements of the hearing partially absorb the microwaves which are used for reading or writing, therefore making communication more difficult.

DE 102006024212 A1 discloses a complete wheel bearing unit with a corresponding IC marking. This can ensure that the corresponding bearing unit can be tracked back.

DE 102005043773 A1 discloses a bearing with an RFID device which receives and stores bearing data and makes the corresponding data available later. The data are used to optimize the maintenance and also contain, for example, operating parameters and information about particular load states which the bearing has passed through.

Against the background of the prior art, the present invention is based on the object of providing a method with which a group of components which respectively have a transponder and a storage device can be marked as efficiently as possible on an individualized basis.

According to the invention, the object is achieved by means of the features of patent claim 1 of the method according to the invention and by a group of components as claimed in patent claim 13. The invention also relates to a container as claimed in patent claim 14 and to a roller bearing as claimed in patent claim 15.

The invention is based on the problem that multiple components which are present in an unmarked state as a group of components are to be marked in a way which is as efficient and individualized as possible, wherein the effort in terms of time and cost is to be minimized. The invention achieves the object by means of a method in which a first marked component enters into contact with second components arranged in the range thereof and transmits information thereto, wherein said components respectively mark themselves while taking into consideration the information transmitted by the first component, and wherein, after marking of at least one second component, said second component enters into contact with further components in the range thereof which are not yet marked in order to bring about the marking thereof.

This procedure is based on the fact that at least one component is present which addresses a subsequent generation of components and requests them, by means of a corresponding signal, to mark themselves. The second components belong here to a generation which follows the generation of the first component. The generation is therefore a first parameter which differentiates the first component from the second components. The second components must then find corresponding self-identifiers using the information which they have obtained from the first component. For this purpose, they can either each communicate individually with the first component, which then administers the necessary different identifiers of the second components, or the second components can communicate with one another in order to avoid identifiers which sound the same. For example, each component can be provided with an algorithm which causes it to register itself with the other components of the same generation and to register its identifier. The component which does this first is accepted by the others and can mark itself first. Afterwards, this process is repeated and that component of the generation which is next to register with the others assigns itself the next identifier until all the components of the generation are marked.

However, it is also possible to provide that in each case the component of the higher generation, that is to say the first component in the specified example, assigns the corresponding identifiers to the components of the second generation, for example by assigning the generation number and by consecutive numbering.

A possible identifying parameter is therefore the designation of the generation of the respective component, that is to say the designation of the number of marking runs already carried out up to its marking. In addition, an identifying parameter may comprise a timestamp which denotes, for example, the time of marking.

As a conclusion of the designated identifying step it is advantageously possible for the first component to register and store the identifying data of the second components. This can subsequently apply to each component with respect to the components in the following generation which are addressed by said component.

In addition or alternatively it may also be advantageous to provide that every second component registers and stores all the identifying data of the other second components. This can also apply to each following generation, with the result that one component of one generation can register and store the identifying data of all the other components of the same generation and advantageously additionally also those of the other generations.

It is therefore possible to address the group of components from the outside via a reading device and to interrogate the data of the entire group by means of a single component from the storage device via its transponder.

This is advantageous in particular if it is not possible to access all the components in a group of components by means of radiofrequency communication since the components are in each other's shadow, which is the case, for example, if they are present as bulk material and are composed at least partially of metal or parts which are composed at least partially of metal are mounted between them.

A similar problem occurs when the components are mounted in a metal container since the metallic sheath thereof also at least partially screens corresponding radio-frequency communication, with the result that only the components of the uppermost layers can be accessed by a read/write device.

It is advantageously possible to provide in the method that before the marking of each unmarked component, said component communicates only with that already marked component which first enters into contact with it.

This avoids the situation in which the unmarked components take up contact in a competitive fashion with multiple components of a previously marked generation, and therefore no uniquely defined marking could be ensured.

Since the already marked components can be identified unambiguously, the components which have not yet been marked can unambiguously define, in their communication, with which of the components which have already been marked and which have entered into contact with them they wish to communicate in order to define their own identifier.

The described method is repeated in successive generations until all the components are addressed, wherein, for example, a container which is filled with corresponding components is successively penetrated depending on the range of the communication. The range of the communication can, for example, be defined by the transmission strength or the reception sensitivity of the transponders. The transmission strength and/or the reception sensitivity can be adjusted at the transponders in order to improve the orderly sequencing of the method.

The communication between the transponders is advantageously synchronized (for example TDMA: time division multiple access). The cyclical communication allows collisions to be avoided. For the transmission of the signals, the frequency spread and the frequency jump behavior can be applied. The reliability of transmission can thereby be increased in the network.

The marking process is advantageously started by a separate transceiver unit or by a transponder which has, for example, the function of a gateway, which is assigned to a container which contains the components and which enters into contact with the components of the group which are not yet marked and which then form the first generation of marked components.

Correspondingly, the information which the respective components acquire by means of their identifiers or the identifiers of the following generations may also be collected in the transponder or the storage device assigned to the container.

For this purpose there is advantageously provision that each component registers, via its transponder, the identifiers of the components with which it has entered into contact, stores said identifiers and passes them on to the component which entered into contact with it before it was marked.

In addition, according to the invention it is also possible to provide that each component has multiple transponders which are respectively assigned to its component elements, wherein the transponders which are respectively assigned to component elements of the same type are associated with separate classes.

For example, in the case of a bearing a transponder and a storage device can be respectively assigned to the different bearing elements, with the result that the individual bearing elements, such as inner ring, outer ring, bearing plates, seal, cage and roller bodies each bear the information about their own manufacturing conditions and/or the operating hours which they have experienced and operating conditions. This information can advantageously also be accumulated in a transponder of the bearing, which transponder then corresponds, after the assembly of the hearing, to the transponders of other bearings in the sense of the method according to the invention.

The transponders can also be organized according to respectively separate classes, with the result that, for example, all the transponders of outer rings of the bearings communicate with one another, and the corresponding transponders of inner rings or bearing plates and so on.

Individualized marking of individual bearing parts is possible before or at the same time as the marking of the bearings.

The invention also relates to a group of components having transponders and storage devices, wherein each of the components has, stored in its storage device, its own identifier and information about the identifiers of all the other components of the group and to a container for carrying out the method according to the invention, wherein the container has a cover which is non-transmissive or the communication of the transponders, and a transponder and a storage device are assigned to the container.

In addition, the invention also relates to a roller bearing having at least one transponder and a storage device, in which the storage device contains an individual identifier which is generated by the method according to the invention.

In a roller bearing it is possible, if individual parts of the bearing are respectively equipped with transponders, for self-diagnosis also to be carried out by means of the main transponder by virtue of the fact that information about the subordinate transponders and/or the corresponding components is stored centrally and compared with data which are acquired later. In this way it is possible to determine within the bearing whether the bearing elements which are provided are present and are in an acceptable state.

The invention will be presented below in a drawing on the basis of an exemplary embodiment and described below. In the drawing:

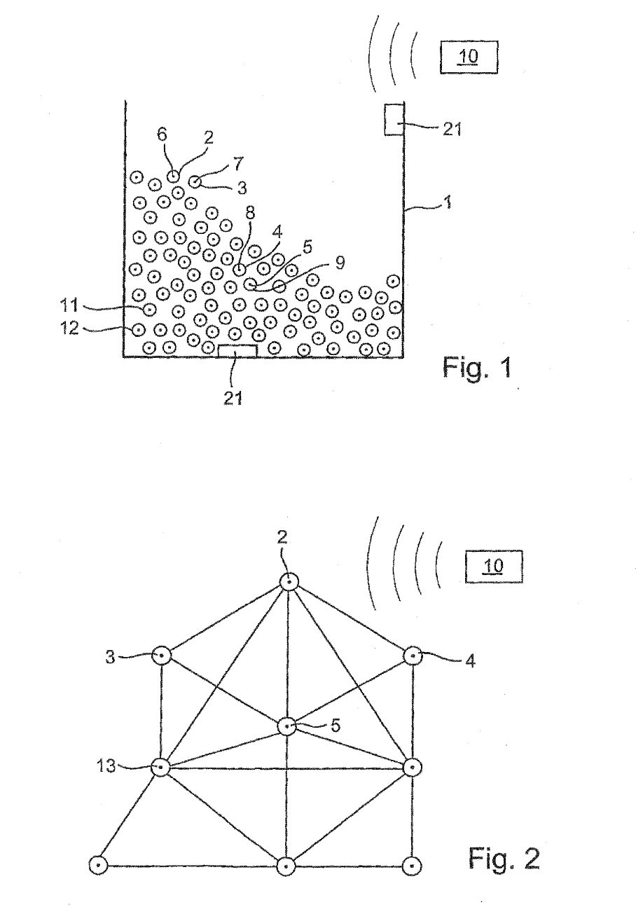

FIG. 1 is a schematic view of a container having bulk material which is composed of metallic objects;

FIG. 2 is a symbolic view of an interlinked network of transponders;

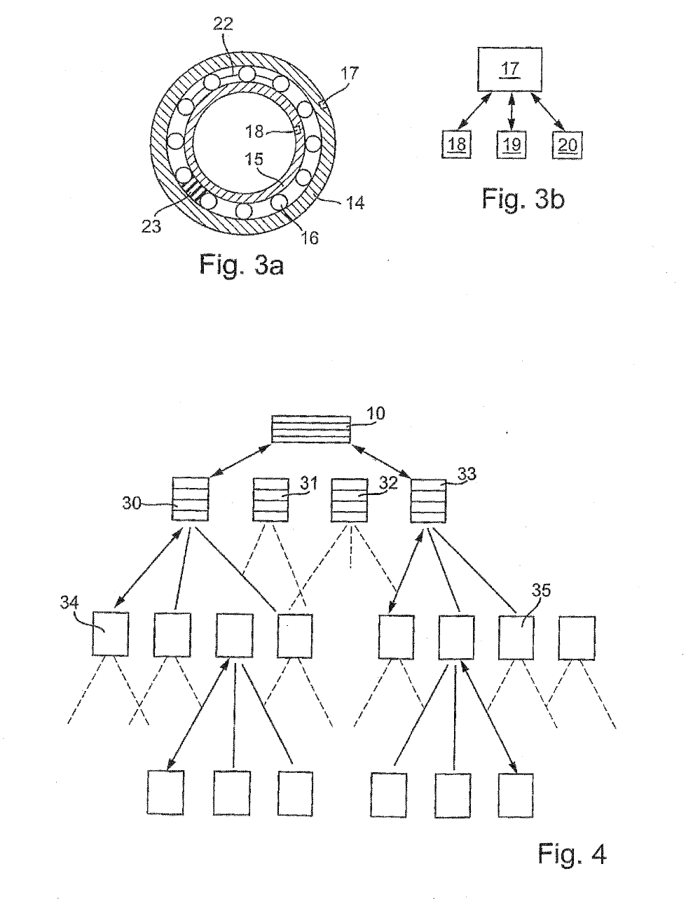

FIG. 3a is a roller hearing in a side view;

FIG. 3h shows various transponders of an individual roller bearing in a schematic form; and

FIG. 4 is a schematic view of an illustration of the self-marking process of the transponders of a group of components.

FIG. 1 is a schematic view of a metallic container 1 which is partially filled with a group of components 2, 3, 4, 5, 11, 12, wherein the components form bulk material, rest loosely one on the other and are composed of a material which at least partially screens electromagnetic waves, and is made, for example, of metal.

The components may be, for example, roller bearings which contain metallic components or are entirely composed of metallic parts.

Each of the components has at least one transponder and a storage device, wherein the individual transponders, together with the respective storage device, are illustrated schematically as points in the center of the components. Such a transponder can receive and emit signals. If the transponder is an RFID transponder, what is referred to as an air interface is provided in the radiofrequency range by using electromagnetic waves. However, other radio signals are also conceivable for transmitting information. Basically, other non-line-bound signals, such as for example infrared waves or ultrasonic waves, are also conceivable for implementing the method according to the invention.

If the intention is to determine which components are present in the container 1 or which container it is, an interrogation signal can be transmitted into the container 1 by a transceiver unit 10 and a response can be waited for. If the individual components 2, 3, 4, 5 or the transponder 21 contain identifiers, they can identify themselves in response to the interrogation by the transceiver unit 10 and transmit back corresponding signals.

The components 11, 12 located in the container further below will not receive the interrogation signal from the transceiver unit 10 since they are screened electromagnetically by the components which are above them. Correspondingly, it is difficult to determine, by means of an interrogation process, the totality of components which are mounted in the container.

This problem is remedied by the invention by virtue of the fact that the components are organized as an interlinked network. For this purpose, the components enter into contact with one another, that is to say because of the limited range of the transponders each individual component enters into contact with the other components which it can access via its transponder.

In response to this, each component copies the information received from its accessible neighbors into the storage device of its own transponder and passes on this information to all the accessible neighbors. After multiple iteration steps of this communication, the storage devices of all the components located in the container 1 therefore contain information about all the components.

After this, an interrogation by the transceiver unit 10 can access each of the components and can interrogate therefrom the number and identity of all the components located in said container.

For this described communication process to function it is firstly necessary to ensure that the individual components mark themselves in an initialization process unless this has already taken place earlier. For this purpose, the transceiver unit 10, as illustrated in FIG. 2, can transmit an initialization pulse to the components which is firstly received and acknowledged by one of the components 2. The transceiver unit 10 then sends to this component 2 a timestamp which is stored in the storage device of the transponder of the component 2. The component receives the information that it is the first marked component and stores this information as part of the self-marking. It is therefore identified as component 1 of the generation 1.

In the next step, the component 2 transmits, within the range of its transponder, a second initialization pulse which is received by the components 3, 4, 5, 13. The individual components 3, 4, 5, 13 are numbered according to a defined algorithm which can, for example, take into account the order in which the components have received the second initialization pulse from the component 2, or the order in which they have acknowledged said initialization pulse.

After this, each of the components 3, 4, 5, 13 have stored the number of its generation, specifically the number 2, and a serial number and a timestamp. These variables are additionally sent to the component 2 and exchanged among the components 3, 4, 5, 13. All of the components of the first and second generation therefore now have information about the identity of the components which are already marked.

Each of the components 3, 4, 5, 13 now for its part transmits a third initialization pulse to the potential components of the third generation. For the purpose of marking, the latter receive the number 3 as the number of the generation and, for example, the identity of the component which has contacted them, as well as a timestamp. This information is also conveyed both within a generation and to the superordinate generations, with the result that at the end of the described iterative process all the components in the container 1 contain the information about all the components.

FIG. 3a shows, for example, a roller bearing such as can be present, for example, as bulk material in the container 1. Such roller bearings usually have an outer ring 14, an inner ring 15, a seal 23 and a roller body 16 and a cage 22 for guiding the roller bodies, wherein most of the components of a roller bearing are composed of metal, at least in the area of relatively high loads.

In the roller bearing shown, a transponder 17 is also illustrated in the outer ring and a transponder 18 in the inner ring. The roller bodies 16, the cage 22 and the seal 23 can also have corresponding transponders. The transponders of the various components of a bearing can enter into communication with one another, with the result that the information about the various components can be exchanged and, for example, stored in a hierarchically prioritized transponder.

FIG. 3b shows such a structure of transponders, wherein the hierarchically prioritized transponder is denoted by 17, while the subordinate transponders are denoted by 18, 19, 20. The system can be configured in such a way that mainly the prioritized transponder 17 communicates externally with other roller bearings, and the subordinate transponders 18, 19, 20 are provided and enabled only for communication within a bearing. This can be implemented, for example, by means of encoding or separate frequency ranges of the corresponding transponders.

In this way, self-diagnosis of the roller bearing becomes possible by virtue of the fact that, for example, timestamps of the individual transponders and therefore manufacturing times of the components of the bearing can be registered and reconciled. The absence of parts can also be detected in an automated fashion in this way.

Overall, each roller bearing can mark itself by means of the described automated process by using a timestamp, with the result that, for example, within one container a production batch bears a specific group identifier which can also be interrogated later after a certain amount of wear of the bearings. On the basis of this identifier it is possible for each bearing to be identified later and analyzed in terms of its service life. The origin or production batch of each bearing can therefore also be tracked. If individual batches have problems, the associated bearings can easily be identified and replaced.

FIG. 4 shows once again the process of self-marking in schematic form, wherein multiple series of transponders are represented with respect to one another and each row represents a generation. The transceiver unit 10 is not associated here with the components which are to be marked but rather only provides the initialization pulse for the marking.

All the transponders 30, 31, 32, 33 which receive their initialization pulse directly from the transceiver unit 10 are associated with the first generation and mark themselves correspondingly including generation number, timestamp and consecutive numbering.

Each of these transponders 30, 31, 32, 33 then attempts to access the other transponders 34, 35 in its range, to which transponders 34, 35 the next generation number together with the updated timestamp and consecutive numbering is assigned. If a transponder of the second generation is contacted by multiple transponders of the first generation, a priority rule is followed which can, for example, entail the transponder entering into contact with that transponder of the higher generation which first contacted it. However, other priority rules are also conceivable.

As a result of the fact that each transponder outputs an initialization pulse to its adjacent transponders only once after its own self-marking, it is ensured that the entire self-marking process is ended after a finite time.

The identifying data about all the generations are then conveyed, with the result that each of the transponders contains data about all the other transponder identifiers and/or component identifiers.

If components which are marked later are placed in a container, they can be organized very quickly through the formation of an interlinked network in a way similar to self-marking, and via the network which is formed they can exchange information with one another about which components are present in the container. This ensures that even in the event of mutual screening information about the totality of the contents of the container can be acquired by means of a transmitter/receiver as a result of the response of at least one component.

The invention therefore significantly simplifies the self-organization of a group of components both when the first marking occurs as well as later during any information gathering process, without organizational expenditure.

### LIST OF REFERENCE NUMERALS

1 Metallic container
2, 3, 4, 5, 11, 12, 13 Components
10 Transceiver unit
14 Outer ring
15 Inner ring
16 Roller body
17 Prioritized transponder
18, 19, 20 Subordinate transponders
21 Transponder for container
30, 31, 32, 33, 34, 35 Transponders

1-15. (canceled)

16. A method for marking multiple components, each of which has at least one transponder and a storage device, the method comprising the steps of:
contacting a first marked component with second components arranged in a range thereof and transmitting information to the second components;
self-marking by at least one of the second components taking into consideration the information transmitted by the first component to the second components; and
after marking of the at least one second component, contacting the at least one second component with further components in a range thereof which are not yet marked in order to bring about a marking of the further components.

17. The method as claimed in claim 16, wherein during the self-marking of the second components, the second components respectively communicate individually with the first component to avoid identical identifiers.

18. The method as claimed in claim 16, wherein during the self-marking of the second components, the second components respectively communicate with each other to avoid identical identifiers.

19. The method as claimed in claim 16, wherein the first component registers and stores identifiers of the second components.

20. The method as claimed in claim 16, wherein each of the second components registers and stores all identifiers of the second components.

21. The method as claimed in claim 16, wherein the components comprise identifying parameters and one of the identifying parameters is a timestamp.

22. The method as claimed in claim 16, wherein the components comprise identifying parameters and one of the identifying parameters contains a designation indicating a number of marking runs already carried out up to a present marking of the component.

23. The method as claimed in claim 16, wherein before marking of each unmarked component, the unmarked component communicates only with a component already marked which first enters into contact with the unmarked component.

24. The method as claimed in claim 16, wherein, at the start of a marking, a transponder, which is assigned to a container containing the components, enters into contact with at least one first unmarked component.

25. The method as claimed in claim 16, wherein, at a start of the marking, a transceiver unit enters into contact with at least one first unmarked component.

26. The method as claimed in claim 16, wherein the multiple components further comprise identifiers and each component registers, via a respective transponder, the identifiers of other components with which the component has entered into contact, stores the identifiers and passes the identifiers on to the other component which entered into contact with the component before the component was marked.

27. The method as claimed in claim 16, wherein each component has multiple transponders which are respectively assigned to elements of the component, wherein transponders assigned to component elements of a same type are associated with classes which can be differentiated.

28. A group of components, each having a transponder; and a storage device, wherein each of the components has an identifier and information about identifiers of all other components of the group stored in the storage device.

29. A container for carrying out a method for marking multiple components, each of which has at least one transponder and a storage device, the method comprising the steps of: contacting a first marked component with second components arranged in a range thereof and transmitting information to the second components; self-marking by at least one of the second components taking into consideration the information transmitted by the first component to the second components; and after marking of the at least one second component, contacting the at least one second component with further components in a range thereof which are not yet marked in order to bring about a marking of the further components,
wherein the container comprises: a cover which is non-transmissive for communication of each transponder; a further transponder; and a storage device.

30. A roller bearing, comprising:
at least one transponder; and
a storage device containing an individual identifier which is generated by a method for marking multiple components including the steps of: contacting a first marked component with second components arranged in a range thereof and transmitting information to the second components; self-marking by at least one of the second components taking into consideration the information transmitted by the first component to the second components; and after marking of the at least one second component, contacting the at least one second component with further components in a range thereof which are not yet marked in order to bring about a marking of the further components.
